(19) United States
(12) Patent Application Publication
(10) Pub. No.: US 2018/0285785 A1
(43) Pub. Date: Oct. 4, 2018

(54) SYSTEM AND METHOD TO MONITOR AIRPLANE RESTROOM USE

(71) Applicant: CHARLES EDISON SMITH, BAHAMA, NC (US)

(72) Inventor: Charles Edison Smith, Bahama, NC (US)

(21) Appl. No.: 15/478,231

(22) Filed: Apr. 3, 2017

(51) Int. Cl. G06Q 10/02; B64D 11/02

(52) U.S. Cl. CPC G06Q 10/025; B64D 11/02

(57) ABSTRACT

The present invention is a system and apparatus, system, and method for providing reservations for restroom use and access to the most conveniently available restroom. In one embodiment, a passenger on an airplane may submit a reservation request to the system for restroom use. The system controller processes the request, assigns a reservation number, determines whether the restroom is available and notifies the passenger when a restroom becomes available. The system seeks to direct the passenger to the restroom closest in proximity to the location of the requesting passenger's seat. The system improves airline safety by minimizing the time passengers spent standing while an airplane is in flight.

### CROSS REFERENCE TO RELATED APPLICATION

This application claims the benefit of U.S. Provisional Application No. 62/317,627, filed Apr. 3, 2016.

### BACKGROUND

### Field of Invention

This invention relates to systems and methods for providing in-flight reservations and use of the airplane restrooms. More particularly, this invention relates to systems and methods designed for multi-passenger orderly turns to visit the airplane's restroom or bathroom while the airplane is in flight.

### Description of Related Art

In a post-9/11 world, security concerns have mandated that commercial airline passengers not congregate in an airplane's aisle during flight. Terms include restrictions on passengers forming a queue while waiting to visit the aircraft's bathroom. But how can many passengers take orderly turns to visit the bathroom if they are not allowed to form a queue?

Even if each passenger were to make an independent decision (from a probability theory viewpoint), there is a good chance that more than one passenger would walk toward the same bathroom; the first one would enter the bathroom, others would have to wait outside the door. In actuality, some in flight events occur that synchronize passenger attempts to visit the bathroom: reaching cruise altitude, completion of a meal, an in-flight movie, commencement of landing preparations. In other words, there are short durations of time in which many people wish to visit an airplane's bathroom.

Additionally, airline passengers are not necessarily efficient at choosing which bathroom to visit. For example, a passenger near the front of the plane may head toward a bathroom simply because of proximity, ignoring an empty bathroom at the rear of the aircraft.

### SUMMARY OF THE INVENTION

The following is an overview of the invention and is not intended in any way to delineate the scope of the invention. The sole purpose of this summary is to present in clear language some aspects of the invention as a prelude to the more detailed description below.

There is a need for an apparatus, system, and method to provide orderly use arid sharing of an airplane's bathroom facilities during flight. In one embodiment, the system arranges for passenger bathroom visits in such a way as to eliminate people congregating or forming a queue in the airplane's aisle at the bathroom door. The desired functionality is achieved by cooperation of passenger seat components and a wireless communication facility.

While in flight, typically, passengers can submit a reservation request for using the restroom from their seats. According to an embodiment of this invention, each passenger seat contains a request unit for use by a passenger to indicate a desire to visit a bathroom. Whenever passenger presses the request button, the system reservation sensor makes a reservation for restroom use in a manner which improves airline safety by minimizing the time passengers spent standing in the aisles. The reservation system processes a passenger's request and assigns a number for the requester. The bathroom sensor unit cooperates with the systems central controller to sense whether a bathroom is occupied or vacant. Then, the system wireless communication will send a notification to the passenger's display when a restroom becomes available for his or her use, according to the reservation number.

The passenger signal mechanism will allow a passenger to press the cancel button if desired to cancel a previous request to visit a bathroom. The central controller assigns passengers to one of the bathrooms according to the vacant bathroom that is closest to the location of the passenger seat. The system functionality indicates to the passenger display that a previously requested bathroom visit has been granted, along with the identification of which bathroom has been assigned for the passenger's request. The system components communicate with each other using wireless communication technology. Additionally, in a preferred embodiment of this invention, an airline crew member may configure and control a particular aspect of the system components under consideration.

### BRIEF DESCRIPTION OF THE DRAWINGS

The accompanying drawings illustrate details of particular aspects of embodiments of the system according to this invention.

FIG. 1 illustrates a high-level view of the system and the wireless communication paths between the components.

FIG. 2 provides an exploded view of an embodiment of a central controller, identifying necessary internal components that contribute to the functionality described by this invention.

FIG. 3 provides an exploded view of an embodiment of an in-seat request unit, identifying internal components that contribute to the functionality outlined by this invention.

FIG. 4 provides an exploded view of an embodiment of a bathroom sensor unit, identifying necessary internal components that contribute to the functionality described by this invention.

### DETAILED DESCRIPTION OF THE PREFERRED EMBODIMENTS

Although the present invention is disclosed with particular reference to the accompanying drawings, it is to be understood at the outset that it is contemplated that the present invention may vary in specific detail from that illustrated and described herein, while still achieving the desired characteristics and features of the present invention. Accordingly, the description that follows is intended to be understood as a broad enabling disclosure directed to persons skilled in the applicable arts and is riot to be understood as being restrictive.

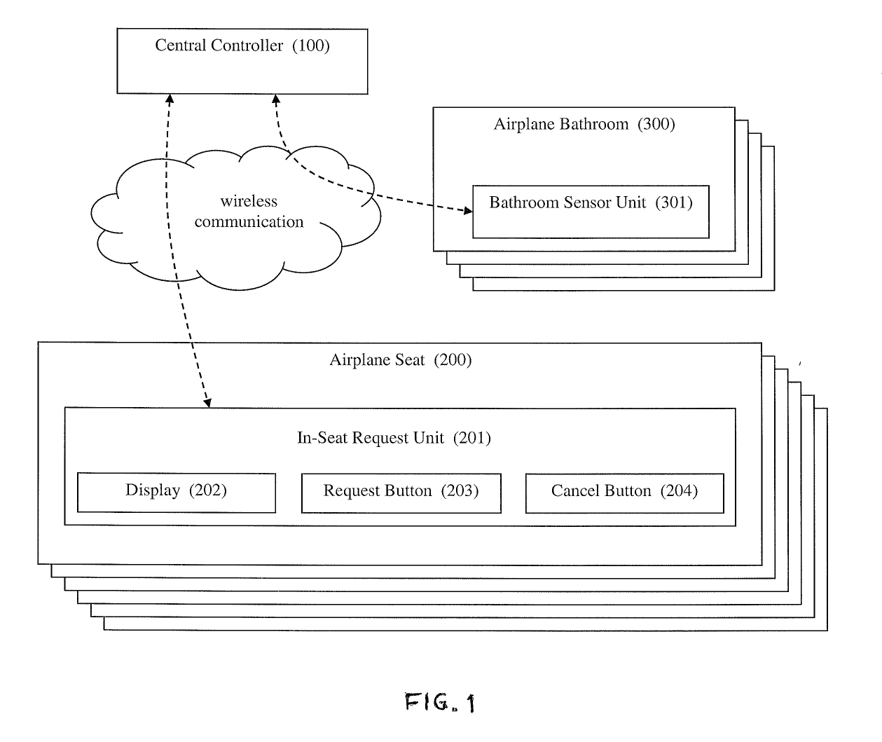

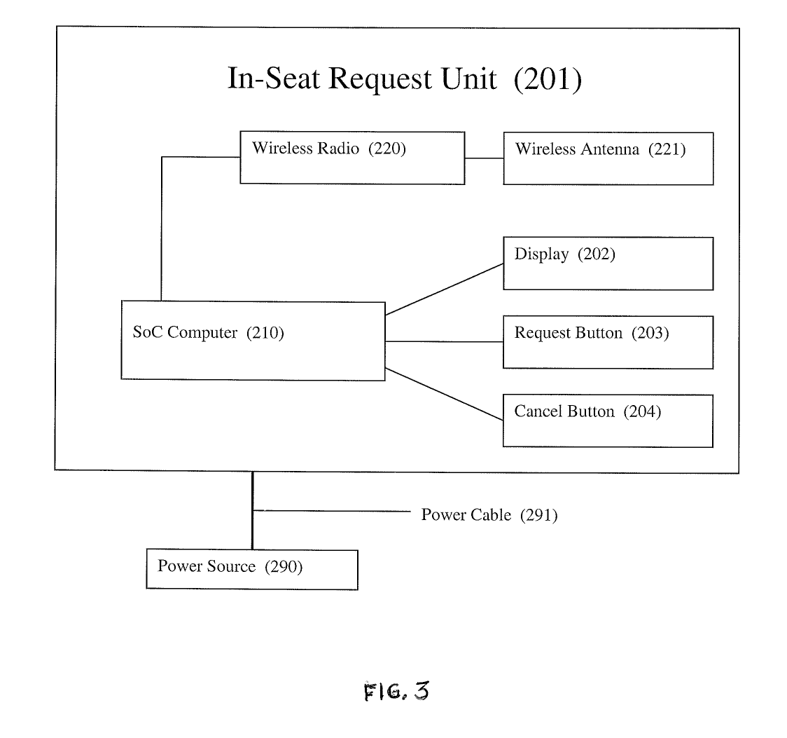

FIGS. 1-4 show one embodiment of a system. Features described herein include six primary mechanisms, which can be arranged in a variety of configurations. First, there is a request mechanism by which an airline passenger signals his desire to visit an airplane bathroom. Second, there is a bathroom mechanism by which the system knows the vacant or occupied status of each airplane bathroom. Third, there is a software algorithm that intelligently assigns each passenger's request to available or unoccupied bathrooms. Fourth, there is a mechanism that indicates the passenger's previous request to visit a bathroom has been granted, along with specifying which bathroom is now vacant. Fifth, there is a mechanism by which the airline crew can manage the system. Sixth, there are wireless communication paths by which the central controller interacts with the other system components.

The overall system apparatus and components include a central controller (100) that contains a SoC computer, wireless radio (120), wireless antenna (121), touchscreen (130), a power source (190) and a power cable (191). The system also includes an in-seat request unit (201). In-seat request unit contains SoC computer (210), display (202), request button (203), cancel button (204) wireless radio (220), wireless antenna (221), a power source (290) and a power cable (291). The system further includes a bathroom sensor unit (301) that contains SoC computer (310), wireless radio (320), wireless antenna (321), occupancy sensor (330), a power source (390) and a power cable (391).

Referring now to FIG. 1, in the preferred embodiment, the central controller (100) contains a SoC computer (110). Software executing on the SoC computer includes algorithms that efficiently map passenger requests to an available or unoccupied bathroom. The algorithms may include the following factors when deciding how passengers are assigned to bathrooms: (1) class of service, such as the first-class versus the economy section, (2) location of unoccupied bathrooms, (3) location of passenger making request. For example, a passenger in the center of the airplane might be assigned a rear bathroom, a middle bathroom, or a forward bathroom; depending on bathroom availability and desired to queue parameters.

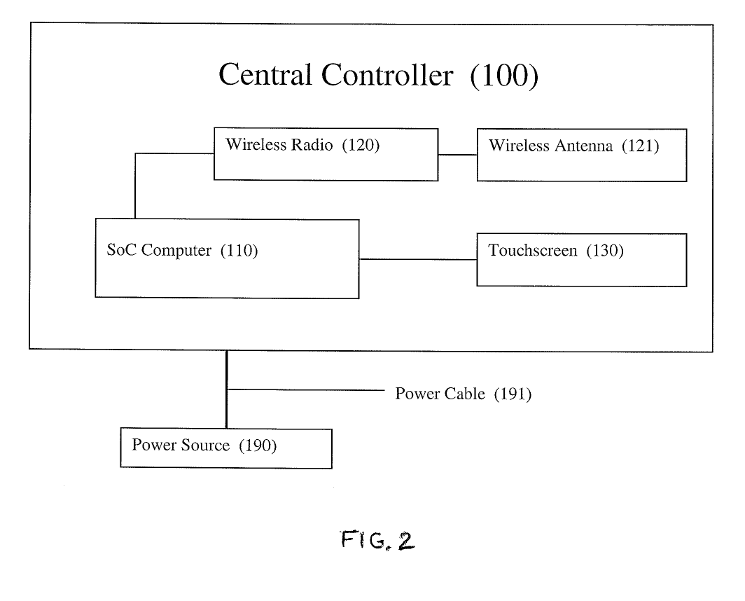

Referring now to FIG. 2, there is disclosed a preferred embodiment of a system of this invention. In this embodiment, each passenger airplane seat (200) contains an in-sear request unit (201), which presents a three element user-machine interface as follows: display (202), request button (203), and cancel button (204). Typically, the passenger signals his or her request to visit a bathroom by depressing the request button. The in-seat request unit contains a SoC (system-on-a-chip) computer (210) that senses the passenger depressing the request button. The system-on-a-chip or SoC can take the form of an integrated circuit (IC) that incorporates all components of a computer or other electronic system into a single chip. The SoC may contain digital, analog, mixed-signal, and often, radio frequency functions, all on a single chip substrate.

The software executing on the SoC computer (210) immediately acknowledges the passenger's request by causing an icon and text to appear on the in-seat request unit's display (202), which the passenger observes. Alternatively, such pending request may be indicated by a light source inside of the request button that is visible to the passenger. Also, SoC (210) computer's software relays a passenger's request to the central controller (100), via wireless communication.

While a passenger's request to visit the bathroom is still pending, if the passenger later changes his or her mind, and decides that no visit to the bathroom is presently required, then, in the preferred embodiment, the passenger may depress the cancel button (204) to cancel the pending request. In this case, the SoC computer (210) senses the passenger depressing the cancel button. Then, software executing on the SoC computer (210) immediately acknowledges the canceled request by removing the icon and text previously appearing on the in-seat request unit's display (202). Alternatively, if the pending request was indicated by a light source inside of the request button, that light is now turned off. Also, SoC computer (210) software relays the passenger's cancellation to the central controller (100), via wireless communication.

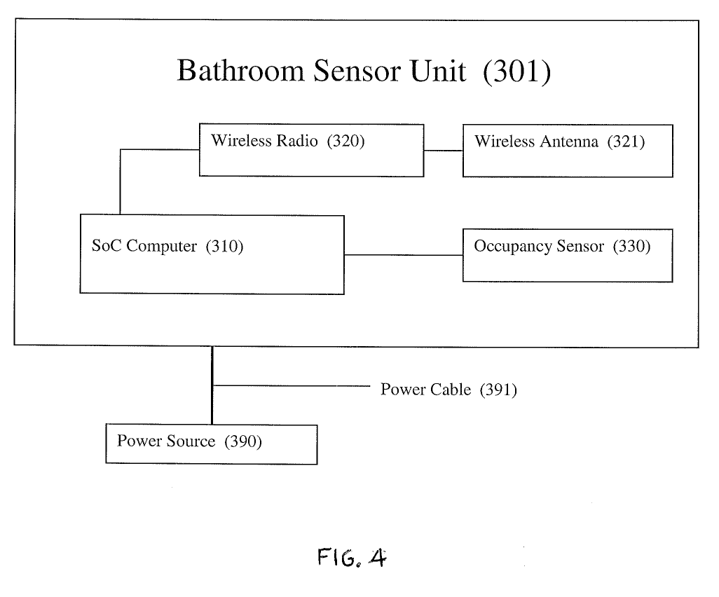

Referring now to FIG. 4, for proper operation, the system must have knowledge of whether each airplane bathroom (300) is currently vacant or occupied. Occupancy information is accomplished in the preferred embodiment by employing a bathroom sensor unit (301) in each of the airplane's bathrooms. Each bathroom sensor unit (301) includes a SoC computer (310) that interfaces to an occupancy sensor (330). By reading data from the occupancy sensor, software executing on the bathroom sensor unit's SoC computer determines whether the bathroom is currently vacant or occupied. In an alternative embodiment, the sensor mechanism could just monitor the on/off status of the light that is commonly used on airplanes to signal bathroom vacancy. The SoC computer (310) software relays the bathroom's occupied or vacant status to the plane's central controller (100), via wireless communication.

Referring further to FIGS. 1-4, in the preferred embodiment of this invention, when a passenger's previous request to visit a bathroom can be granted, the in-seat request unit (201) receives a notification sent from the central controller (100), via wireless communication. The notification specifies which bathroom the passenger should use. The software executing on the in-seat request unit's SoC computer (210) displays an icon and text on the in-seat request unit's display (202) to indicate which bathroom is now vacant for the passenger's use. If the pending request was indicated by a light source inside of the request button, that light is now turned off.

Referring still to FIGS. 1-4, according to the preferred embodiment of this invention, the central controller (100) also contains a touch screen display (130) that provides the user-machine interface for the airplane crew's control of the system. Software executing on the central controller's SoC computer (110) implements a menu-driven graphical interface that allows the flight team to configure which languages will be displayed on the in-seat request unit's display (202). The software will also restore a bathroom from inactive to active service, remove a bathroom from active service to inactive service, suspend system operation when passengers must remain seated (during takeoff, landing, or turbulence), and select policies for assignment of passengers to bathrooms.

The preferred embodiment leverages wireless communications to distribute functionality among system components. Accordingly, each system component must contain baseband and radio-frequency elements required to access the wireless medium. Within the central controller (100), the SoC computer (110) interfaces with the wireless radio (120), which transmits and receives information to/from other system components via the wireless antenna (121). Within each in-seat request unit (201), the SoC computer (210) interfaces with the wireless radio (220), which transmits and receives information to/from the central controller via the wireless antenna (221). Within each bathroom sensor unit (301), the SoC computer (310) interfaces with the wireless radio (320), which transmits and receives information to/from the central controller via the wireless antenna (321).

It is recognized that the use of wireless communication technology requires careful design to minimize radio interface with other equipment. Of utmost importance is the guarantee that the airplane's cockpit and other flight control systems are not affected by the system described herein. Also, there may be other non-critical aircraft systems that must not be affected. Finally, electronic devices used by passengers (e.g. laptops, cell phones, music players) should not interfere with the system described herein.

It is also recognized that the use of wireless communication technology requires attention to potential security issues. The system must be resistant to “hacking” (i.e. intentional tampering) by passengers using conventional consumer electronics.

It is anticipated that both the avoidance of radio interference and security against hacking attacks will be addressed by careful choice of the carrier frequency for wireless communications used by this system. Given that the wireless communication paths need to be operational only during the period that starts after takeoff and ends before landing, there should be considerable freedom to choose an appropriate carrier frequency.

Finally, all of the system components require electrical power to function. The central controller (100) receives its power from a power source (190) via a power cable (191). Each in-seat request unit (201) receives its power from a power source (290) via a power cable (291). Each bathroom sensor unit (301) receives its power from a power source (390) via a power cable (391).

What is claimed is:

1. A method of providing reservations for restroom use comprising:
sending a passenger reservation request to use an inflight airplane restroom; receiving a restroom reservation request from the passenger; determining the passenger seat location number;
assigning a passenger reservation request number; determining the occupancy or vacancy of a restroom; and notifying the passenger with lowest reservation request number when a restroom closest to passenger seat location.

2. An apparatus for providing reservations for restroom use, comprising:
a central controller; an in-seat request unit; a bathroom senor unit; and a wireless communication system provided with communication paths to enable the central controller to interact and cooperate with the system components of the in-seat request unit and the bathroom sensor unit.

3. The apparatus according to claim 2, wherein said in-seat request unit includes a request mechanism by which an airline passenger signals a desire to visit an airplane bathroom.

4. The apparatus according to claim 3, wherein said central controller communicates via the wireless communication system with an occupancy sensor located within the bathroom sensor unit to ascertain the occupancy or vacancy status of each airplane bathroom, said central controller further comprises a software algorithm that assigns each passenger request across available bathrooms.

5. The apparatus according to claim 4, wherein said central controller software algorithm indicates to the passenger whether the passenger's previous request to visit a bathroom has been granted and specify which bathroom is now vacant.

6. The apparatus according to claim 5, wherein said central controller further comprises a mechanism which enables the airline crew to manage the system
